(19) United States
(12) Patent Application Publication
(10) Pub. No.: US 2024/0300735 A1
(43) Pub. Date: Sep. 12, 2024

(54) MODULAR SYSTEM FOR STORAGE OF LONG ELONGATED LOADS

(71) Applicant: SINASE ACEROS Y SERVICIOS S.A., TUDELA (Navarra) (ES)

(72) Inventor: Iker SERRANO GARCÍA, TUDELA (Navarra) (ES)

(21) Appl. No.: 18/599,655

(22) Filed: Mar. 8, 2024

(30) Foreign Application Priority Data
Mar. 9, 2023 (ES) 202330194

(51) Int. Cl. B65G 1/04

(52) U.S. Cl. CPC B65G 1/0442; B65G 2201/0217

(57) ABSTRACT

A load storage system for elongated elements comprising at least two gantries, wherein each gantry is formed by at least two vertical supports and at least one beam supported by the at least two vertical supports, such that between two adjacent gantries at least one load storage space is formed, such that each beam defines a storage level, wherein the system comprises: a base comprising of at least two open profiles with the outer face of their web resting on a support surface, so that the vertical supports rest on the open profiles, and a support piece, which can be anchored to the vertical supports and in turn supported on the inner face of the web of the open profiles.

### PRIORITY CLAIM

This application claims priority to Spanish Patent Application No. 202330194, filed Mar. 9, 2023, which is expressly incorporated by reference herein.

### BACKGROUND

The present disclosure relates to a modular system for the storage of loads of elongated elements, which has application in the logistics industry, and more specifically in the field of storage systems.

### SUMMARY

According to the present disclosure, a modular system for storing loads of elongated elements allows the dimensions of the system to be open and easily reconfigured, allowing for maximum use of space and a combination of both dimensions and anchorages.

In illustrative embodiments, the system comprises at least two gantries, where each gantry is formed by at least two vertical supports and at least one beam supported on the at least two vertical supports, such that between two contiguous gantries at least one load storage space is formed, such that each beam defines a storage level.

In illustrative embodiments, the system comprises a base formed by at least two open profiles with the outer face of the web resting on a support surface (B), so that the vertical supports rest on the open profiles.

In illustrative embodiments, the system also includes a support piece, which can be anchored to the vertical supports and can rest on the inner face of the web of the open profiles.

In illustrative embodiments, the system is a completely modular system, which allows dismantling it to move it to a new location, make it grow in height, extend it in length, add trays to carry material, divide the openings into several parts to allow the storage of more than one material in a single location.

Additional features of the present disclosure will become apparent to those skilled in the art upon consideration of illustrative embodiments exemplifying the best mode of carrying out the disclosure as presently perceived.

### BRIEF DESCRIPTIONS OF THE DRAWINGS

The detailed description particularly refers to the accompanying figures in which:

FIG. 1 shows a schematic perspective view of one of the open profiles that constitute the base of the gantries and on which the support pieces are arranged.

FIG. 2 shows a schematic exploded view representing a sequential moment of the assembly, where two bases and an end gantry can be seen.

FIG. 3 shows a detail in which the means of rapid fastening of the vertical supports of the gantries to the support piece can be seen, as well as the connection of the gantry beams to the vertical supports, which have been shown in translucent form for a better appreciation of these means of rapid fastening.

FIG. 4 shows a detail of the arrangement of a support piece in the open profile that serves as a base, as well as one of the cross beams.

FIG. 5 shows a detail of the connection between an end portal frame and the open profile by means of a support piece in a closed box.

FIG. 6 shows an enlarged perspective view of the detail shown in FIG. 5.

FIG. 7 shows a perspective view of the system of the present disclosure in which the closed profiles that allow the connection in different sections of the vertical supports can be seen.

FIG. 8 shows a detail of the closed profiles shown in FIG. 7.

FIG. 9 shows a perspective view of the system shown in FIG. 7 at a more advanced stage of assembly with the sections of the vertical supports connected by means of the closed profiles.

FIG. 10 shows a detail of the connection of the second horizontal open profile with the vertical supports.

FIG. 11 shows a perspective view of the upper platform of the system after completion of assembly.

FIG. 12 shows a perspective view of the open profiles that constitute the base of a variant of realization of the system detailing the system of the present disclosure in which each gantry has three anchorage points.

FIG. 13 shows a perspective view of the complete system of the variant shown in FIG. 12.

FIG. 14 shows a perspective view of the upper platform.

FIG. 15 shows a detail of a mobile trolley for the arrangement of elongated elements.

FIG. 16 shows a detail in which the arrangement of elongated elements in the system of the present disclosure can be appreciated.

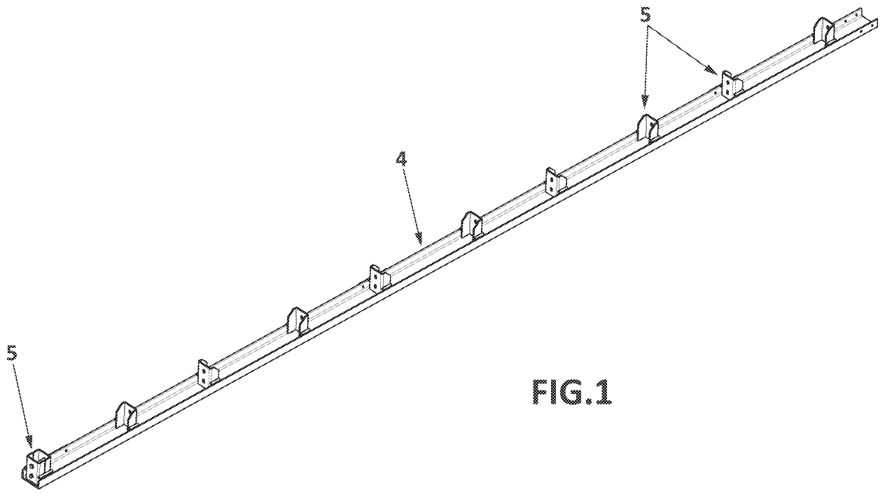

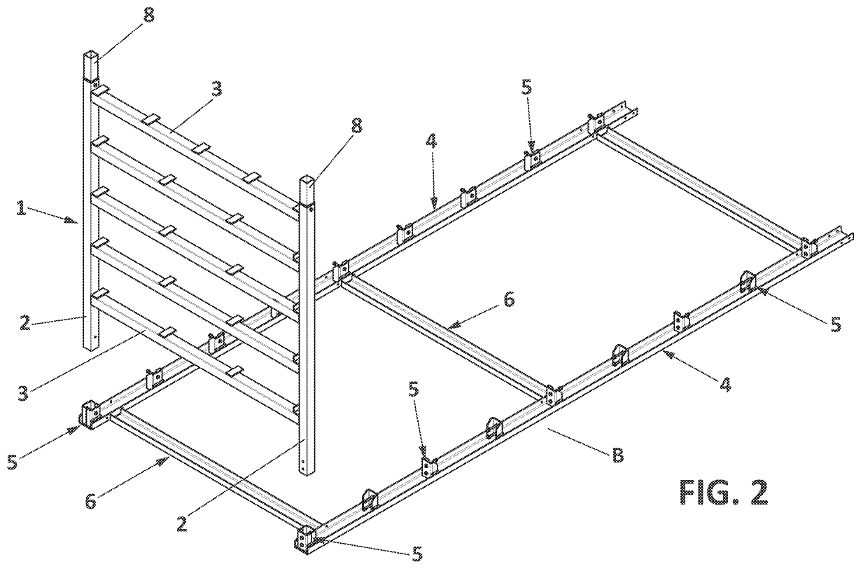

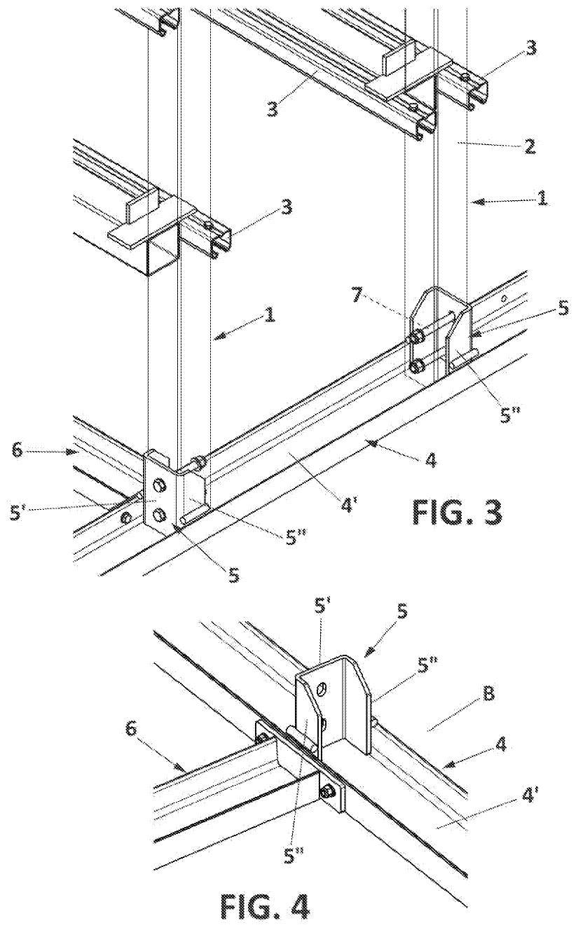

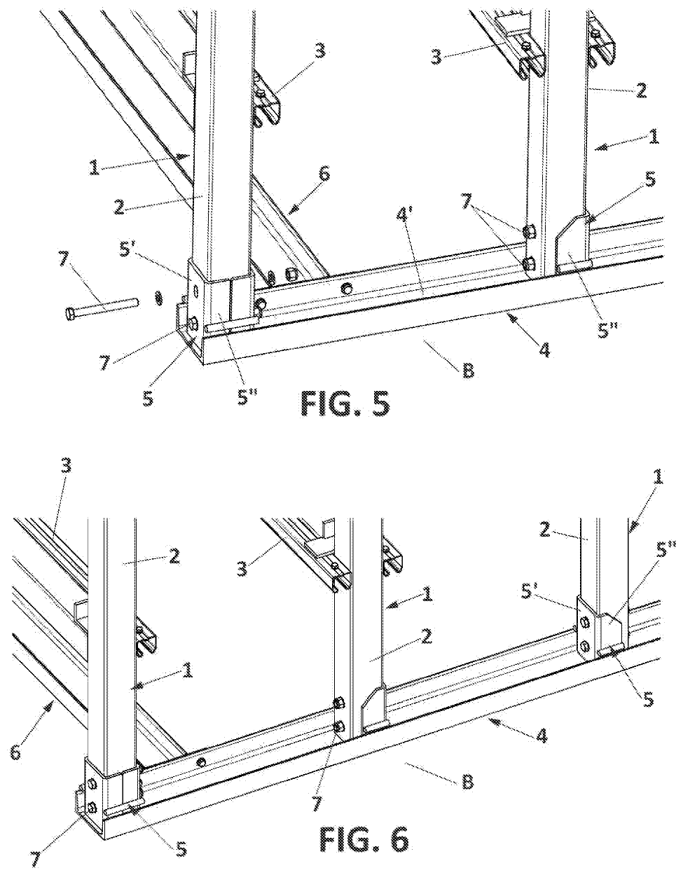

### DETAILED DESCRIPTION

In view of the figures shown, it can be seen that in one of the possible embodiments of the present disclosure, the load storage system for elongated elements (A) proposed by the present disclosure comprises at least two gantries (1), where each gantry (1) is formed by at least two vertical supports (2) and at least one beam (3) supported by the at least two vertical supports (2), such that between two contiguous gantries (1) at least one load storage space is formed, such that each beam (3) defines a storage level.

The system also comprises:
a base comprising of at least two open profiles (4) with the outer face of their web (4′) resting on a support surface (B), so that the vertical supports (2) rest on the open profiles (4), and
a support piece (5), which can be anchored to the vertical supports (2) and in turn supported on the inner face of the web (4′) of the open profiles (4).

For increased safety and robustness, the open profiles (4) are to be anchored to the supporting surface (B), if necessary only.

In the same way, and depending on the total size of the system, it is envisaged that at least two adjacent open profiles (4) will be joined together by anchoring them to at least one brace beam (6).

According to a preferred embodiment, the open profiles (4) are standard metal U-profiles.

Preferably, the support pieces (5) are open U-shaped profiles in which the plane of their web (5′) is arranged perpendicular to the support surface (B).

In this sense, it is envisaged that the support pieces (5) corresponding to intermediate frames (1) will have the wings (5″) at their free end trimmed, while the support pieces (5) corresponding to the end frames (1) will take the form of two open profiles arranged in a closed box.

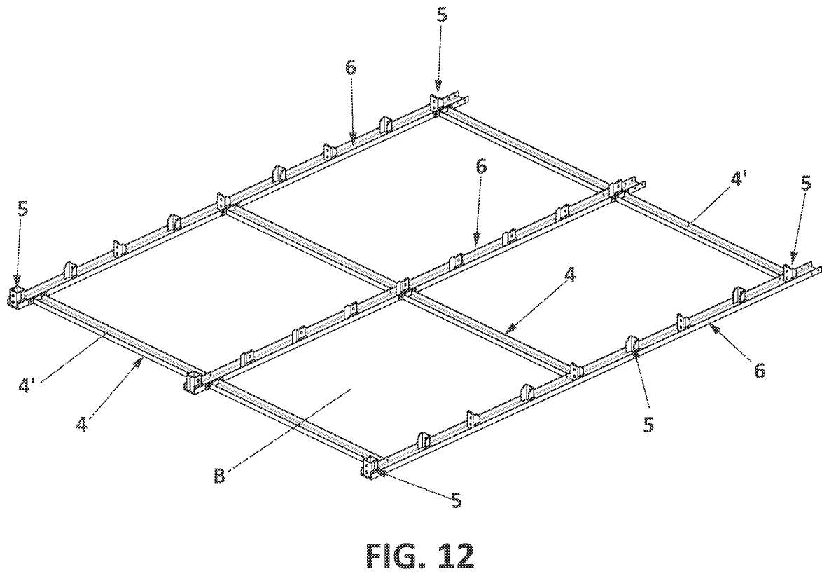

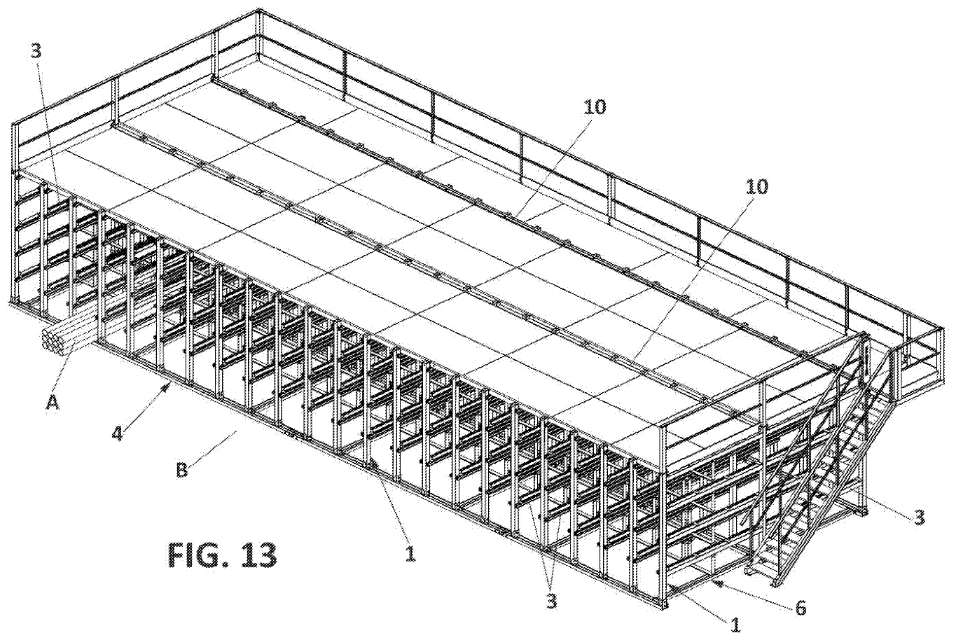

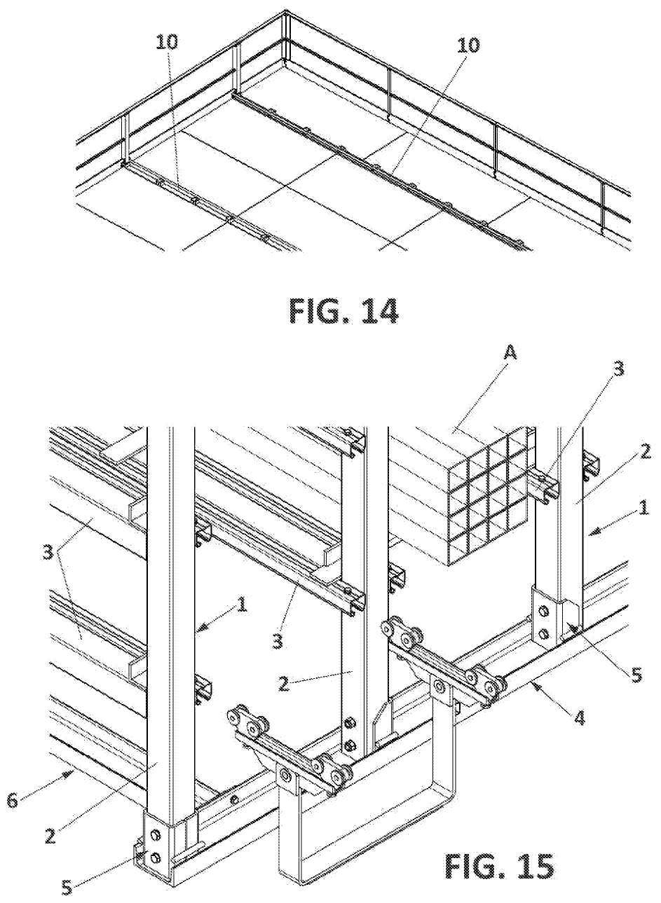

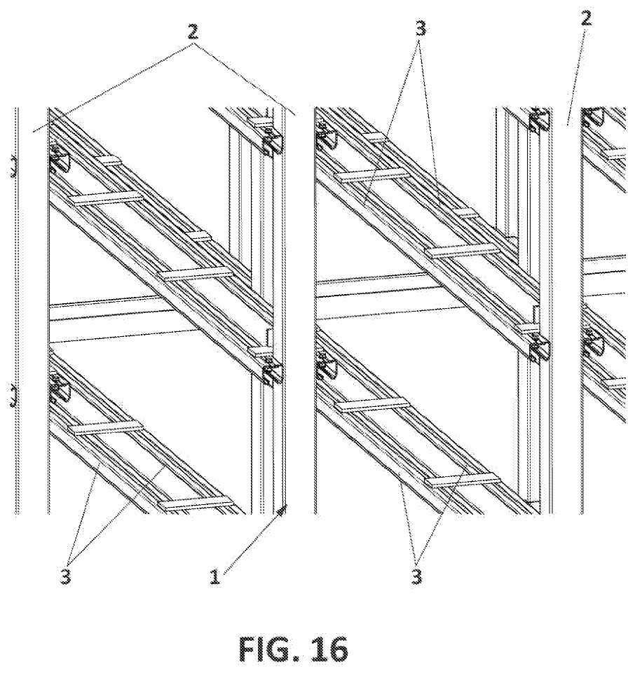

As shown in the embodiments of FIGS. 12 and 13, a variant of the system is that each gantry (1) is made up of three vertical supports (2).

Preferably, each support piece (5) is anchored to a vertical support (2) by means of quick fasteners (7), which may comprise pins, bolts, rivets, and screws.

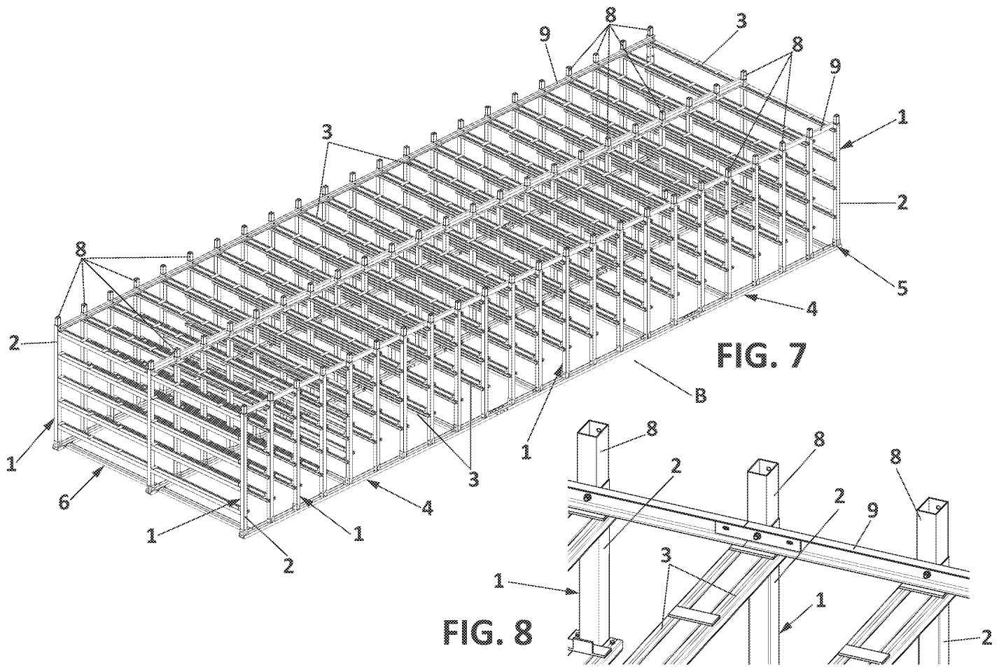

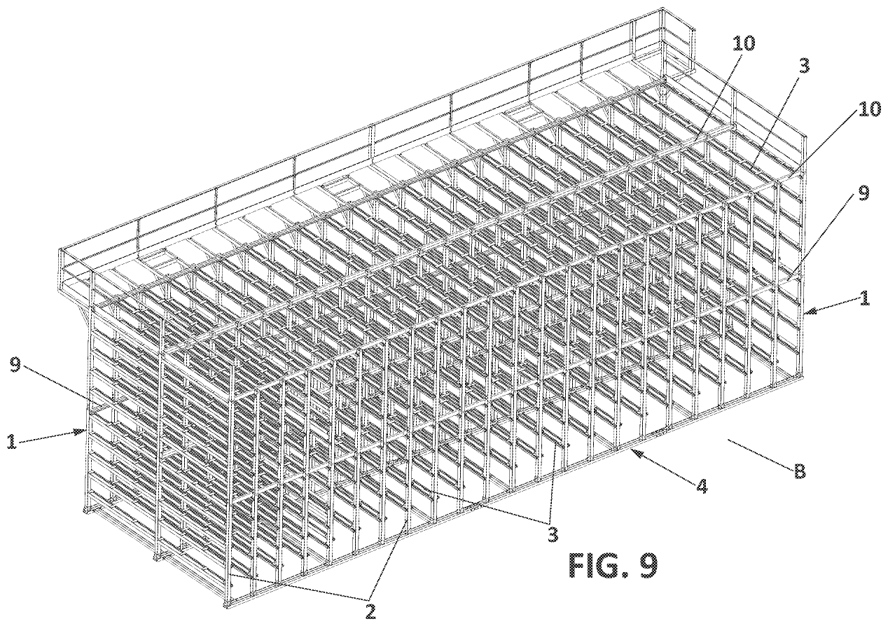

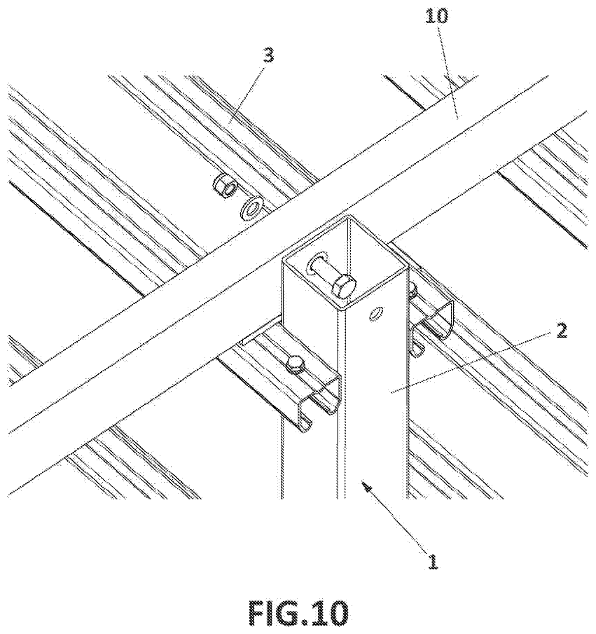

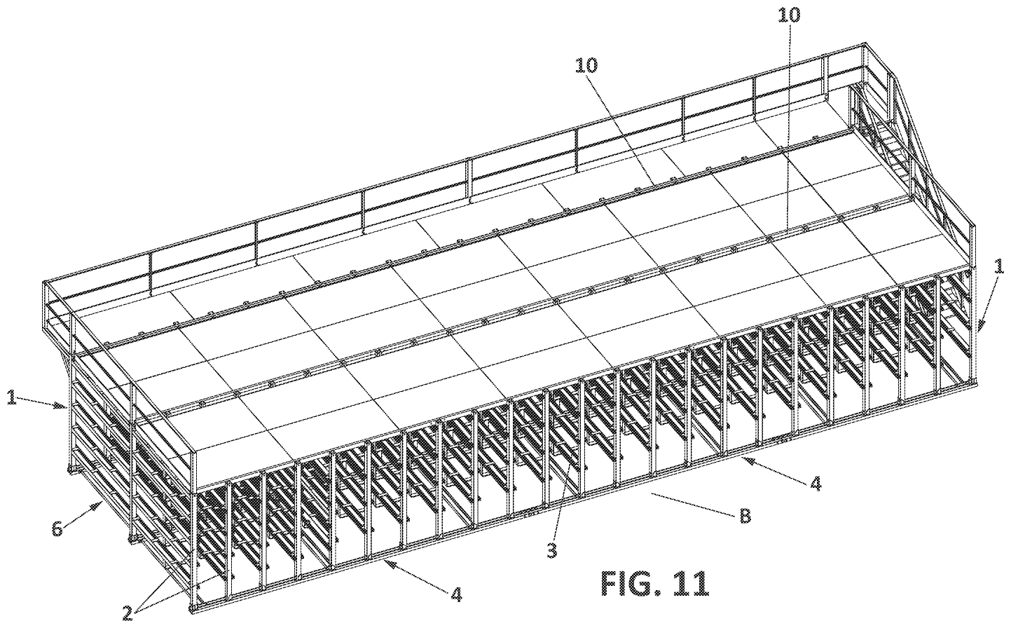

As shown in FIGS. 7 to 11, it is envisaged that each vertical support (2) comprises at least two sections that are connected by means of a closed profile (8) that is internally aligned with respect to the vertical supports (2) for the correct load transmission and is fastened by means of screws or bolts.

It is also envisaged that the system comprises at least one horizontal open profile (9) for bracing the lower section of the vertical supports (2), so that the fastening by means of screws or bolts is made between the closed profiles (8), the lower sections of the vertical supports (2) and the horizontal open profile (9) itself, bracing the lower structure and serving as support for the package (A) placed immediately above.

Finally, the upper free ends of the vertical supports (2) are braced by means of at least a second horizontal open profile (10) that is fastened by means of screws or bolts to the vertical support (2) itself, bracing the structure and serving as a support element for the packages (A) placed in the upper warehouse or platform.

In view of this description and set of figures, the person skilled in the art will understand that the embodiments of the present disclosure that have been described can be combined in multiple ways within the subject matter of the present disclosure. The present disclosure has been described according to some preferred embodiments thereof, but it will be apparent to the person skilled in the art that multiple variations can be introduced into such preferred embodiments without exceeding the claimed subject matter of the present disclosure.

The present disclosure relates to a modular system for the storage of loads of elongated elements, which has application in the logistics industry, and more specifically in the field of storage systems, allowing to improve the efficiency of the current systems, with a considerable reduction of the assembly time, by allowing to pass from the current fixed storage systems, in which the elements were welded at the assembly location, to a completely modular system that can be disassembled to move it to a new location, grow in height, expand in length, add trays to carry material, divide the openings into several parts to allow more than one material to be stored in a single location and with a modular system that offers multiple possibilities in a simple and quick way.

Comparative storage systems may use metal profiles, which are used in particular for the storage of long elements such as pipes. These comparative systems consist of a plurality of gantries whose elements are welded in their final location according to the configuration chosen by their user.

This comparative method of assembly, apart from being time-consuming and costly, due to the need to move welding equipment, does not offer any possibility of changing the configuration of the system once it has been assembled, depending on the user's needs and any changes that may occur.

The present disclosure relates to a modular system for storing loads of elongated elements as defined in claim 1 of the present application. The system allows the dimensions of the system to be open and easily reconfigured, allowing for maximum use of space and a combination of both dimensions and anchorages.

The system that the present disclosure proposes comprises at least two gantries, where each gantry is formed by at least two vertical supports and at least one beam supported on the at least two vertical supports, such that between two contiguous gantries at least one load storage space is formed, such that each beam defines a storage level.

According to the present disclosure, the system comprises a base formed by at least two open profiles with the outer face of the web resting on a support surface (B), so that the vertical supports rest on the open profiles.

The system also includes a support piece, which can be anchored to the vertical supports and can rest on the inner face of the web of the open profiles.

With respect to the state of the art, the main difference over time is the change from a fixed storage system that was carried out by welding at the customer's premises, to a completely modular system, which allows us to dismantle it to move it to a new location, make it grow in height, extend it in length, add trays to carry material, divide the openings into several parts to allow the storage of more than one material in a single location.

Load storage system for elongated elements (A) comprising at least two gantries (1), wherein each gantry (1) is formed by at least two vertical supports (2) and at least one beam (3) supported by the at least two vertical supports (2), such that between two adjacent gantries (1) at least one load storage space is formed, such that each beam (3) defines a storage level, wherein the system comprises:
a base comprising of at least two open profiles (4) with the outer face of their web (4′) resting on a support surface (B), so that the vertical supports (2) rest on the open profiles (4), and
a support piece (5), which can be anchored to the vertical supports (2) and in turn supported on the inner face of the web (4′) of the open profiles (4).

The following numbered clauses include embodiments that are contemplated and non-limiting:

Clause 1. Load storage system for elongated elements (A) comprising at least two gantries (1), where each gantry (1) is formed by at least two vertical supports (2) and at least one beam (3) supported on the at least two vertical supports (2), such that between two contiguous gantries (1) at least one load storage space is formed, so that each beam (3) defines a storage level, wherein it comprises:
a base comprising of at least two open profiles (4) with the outer face of their web (4′) resting on a support surface (B), so that the vertical supports (2) rest on the open profiles (4), and
a support piece (5), which can be anchored to the vertical supports (2) and in turn supported on the inner face of the web (4′) of the open profiles (4).

Clause 2. System according to clause 1, wherein the open profiles (4) are anchored to the support surface (B).

Clause 3. System according to any of the previous clauses, in which at least two contiguous open profiles (4) are joined together by means of their anchorage with at least one brace beam (6).

Clause 4. System according to any of the previous claims, in which the open profiles (4) are standard metal U-profiles.

Clause 5. System according to any of the previous clauses, in which the support pieces (5) are open U-shaped profiles in which the plane of their web (5′) is arranged perpendicular to the support surface (B).

Clause 6. System according to clause 5, in which the support pieces (5) corresponding to intermediate frames (1) have the wings (5″) at their free end trimmed, while the support pieces (5) corresponding to the end frames (1) are materialised as two open profiles arranged in a closed box.

Clause 7. System according to any of the previous clauses, in which each gantry (1) is formed by three vertical supports (2).

Clause 8. System according to any of the previous clauses, in which each support piece (5) is anchored to a vertical support (2) by means of quick fasteners (7).

Clause 9. System according to clause 8, wherein the quick fastening means (7) comprise pins.

Clause 10. System according to clause 8, wherein the quick fastening means (7) comprise bolts.

Clause 11. System according to clause 8, wherein the quick fastening means (7) comprise rivets.

Clause 12. System according to clause 8, wherein the quick fastening means (7) comprise screws.

Clause 13. System according to any of the previous clauses, in which each vertical support (2) comprises at least two sections that are connected by means of a closed profile (8) that is internally aligned with respect to the vertical supports (2) for the correct transmission of the load and which is fastened by means of screws or bolts.

Clause 14. System according to clauses 13, comprising at least one horizontal open profile (9) for bracing the lower section of the vertical supports (2), so that the fastening by means of screws or bolts is carried out between the closed profiles (8), the lower sections of the vertical supports (2) and the horizontal open profile (9) itself, bracing the lower structure.

Clause 15. System according to any of the previous clauses, in which the upper free ends of the vertical supports (2) are braced by means of at least a second horizontal open profile (10) that are fastened by means of screws or bolts to the vertical support (2) itself.

1. A load storage system for elongated elements, the load storage system comprising at least two gantries, where each gantry is formed by at least two vertical supports and at least one beam supported on the at least two vertical supports, such that between two contiguous gantries at least one load storage space is formed, so that each beam defines a storage level, wherein it comprises:
a base comprising of at least two open profiles with the outer face of their web resting on a support surface, so that the vertical supports rest on the open profiles, and
a support piece, which can be anchored to the vertical supports and in turn supported on the inner face of the web of the open profiles.

2. The load storage system of claim 1, wherein the open profiles are anchored to the support surface.

3. The load storage system of claim 1, in which at least two contiguous open profiles are joined together by means of their anchorage with at least one brace beam.

4. The load storage system of claim 1, in which the open profiles are metal U-profiles.

5. The load storage system of claim 1, in which the support pieces are open U-shaped profiles in which the plane of their web is arranged perpendicular to the support surface.

6. The load storage system of claim 5, in which the support pieces corresponding to intermediate frames have the wings at their free end trimmed, while the support pieces corresponding to the end frames are arranged as two open profiles arranged in a closed box.

7. The load storage system of claim 1, in which each gantry is formed by three vertical supports.

8. The load storage system of claim 1, in which each support piece is anchored to a vertical support by means of quick fasteners.

9. The load storage system of claim 8, wherein the quick fastening means comprise pins.

10. The load storage system of claim 8, wherein the quick fastening means comprise bolts.

11. The load storage system of claim 8, wherein the quick fastening means comprise rivets.

12. The load storage system of claim 8, wherein the quick fastening means comprise screws.

13. The load storage system of claim 1, in which each vertical support comprises at least two sections that are connected by means of a closed profile that is internally aligned with respect to the vertical supports for the correct transmission of the load and which is fastened by means of screws or bolts.

14. The load storage system of claim 13, comprising at least one horizontal open profile for bracing the lower section of the vertical supports, so that the fastening by means of screws or bolts is carried out between the closed profiles, the lower sections of the vertical supports and the horizontal open profile itself, bracing the lower structure.

15. The load storage system of claim 1, in which the upper free ends of the vertical supports are braced by means of at least a second horizontal open profile that are fastened by means of screws or bolts to the vertical support itself.
